(19) United States
(12) Patent Application Publication
(10) Pub. No.: US 2006/0194177 A1
(43) Pub. Date: Aug. 31, 2006

(54) Educational game and method of playing the same

(76) Inventor: Nancy Vaughan, Newport Beach, CA (US)

Correspondence Address: CHRISTIE, PARKER & HALE, LLP, PO BOX 7068, PASADENA, CA, 91109-7068, US

(21) Appl. No.: 11/351,548

(22) Filed: Feb. 10, 2006

Related U.S. Application Data
(60) Provisional application No. 60/652,156, filed on Feb. 11, 2005.

(51) Int. Cl. G09B 19/00

(52) U.S. Cl. 434/238

(57) ABSTRACT

An educational game for getting a person to complete chores and a method of playing the same are provided. The game includes a plurality of cards having a first face opposite a second face and having a chore identified on the first face. The game also includes means for suspending each of said card on a surface. The method includes providing a plurality of cards each card having a first face opposite a second face, and each card having a chore identified at the first face thereof. The method also includes positioning the cards with their first face showing the chores to be completed. Moreover, the method includes having a person complete each chore as set forth in each card and after completion of each chore turning the card over exposing the second face of the card.

### CROSS-REFERENCE TO RELATED APPLICATION(S)

This application is based upon and claims priority on U.S. Provisional Application No. 60/652,156 filed on Feb. 11, 2005, the contents of which are fully incorporated herein by reference.

### BACKGROUND OF THE INVENTION

Motivating people to do certain tasks or chores may be difficult. As such a game is desired that will provide the motivation to people to complete desired tasks or chores.

### SUMMARY OF THE INVENTION

In an exemplary embodiment a method is provided for getting a person to complete chores. The method includes providing a plurality of cards each card having a first face opposite a second face, and each card having a chore identified at the first face thereof. The method also includes positioning the cards with their first face showing the chores to be completed. Moreover, the method includes having a person complete each chore as set forth in each card and after completion of each chore turning the card over exposing the second face of the card, such that when all the card are turned exposing their second face, the method is completed. In another exemplary embodiment, the second face of each card has a mark denoting completion of the chore. In an exemplary embodiment the mark is the word “done”.

In another exemplary embodiment, the method may include marking the second face of each card when the chore set forth in each card is completed. In yet a further exemplary embodiment providing a plurality of cards includes providing a plurality of cards each card having a first face opposite a second face, and marking the first face of each card with a marking identifying a chore. In yet another exemplary embodiment, the method also includes providing a set of hooks, and mounting the hooks on a surface. With this embodiment, positioning of the cards includes mounting each card on a hook mounted on said surface such that each card is mounted on a different hook with the first face of each card being exposed. In another exemplary embodiment, after each chore is completed the appropriate card mounted on a hook of the plurality of hooks is dismounted from the hook and remounted with the second face of the card being exposed denoting completion of the chore identified in the first face of such card.

In yet another exemplary embodiment each chore is identified by either writing and/or a figure on the first face of each card. In yet a further exemplary embodiment, providing a plurality of cards includes providing at least one blank card and a marker for marking the first face of the blank card for identifying a chore. In an exemplary embodiment, the marker non-permanently marks the card.

In another exemplary embodiment a game is provided for motivating a person to complete a chore. The game includes a plurality of cards having a first face opposite a second face and having a chore identified on the first face. The game also includes means for suspending each of said card on a surface. In one exemplary embodiment the means is a plurality of hooks for mounting on a surface. With this exemplary embodiment each of the cards comprises an opening for mounting on a hook of the plurality of hooks. In another exemplary embodiment the game may include one or more cards having a generally blank first surface. The game may also include a marker for marking the blank first surface of such cards. In yet a further exemplary embodiment, each card may include a marking on their second face designating the completion of a chore designated in such card first surface. In yet a further exemplary embodiment, each card may be laminated. In this regard markings may be made on the cards using an erasable marker such as a dry-erase type of marker which markings can then be easily erased. The games may include multiple sets of cards, each set identifying chores to be accomplished before different events.

### BRIEF DESCRIPTION OF THE DRAWINGS

FIGS. 1-6 depicts the front faces of exemplary cards of an exemplary game identifying various tasks or chores.

FIG. 7 depicts the rear face of an exemplary card of an exemplary game.

FIG. 8 depicts the front face of an exemplary blank card.

FIG. 9 depicts an exemplary embodiment set of cards of an exemplary embodiment game hanging on a wall.

### DETAILED DESCRIPTION OF THE INVENTION

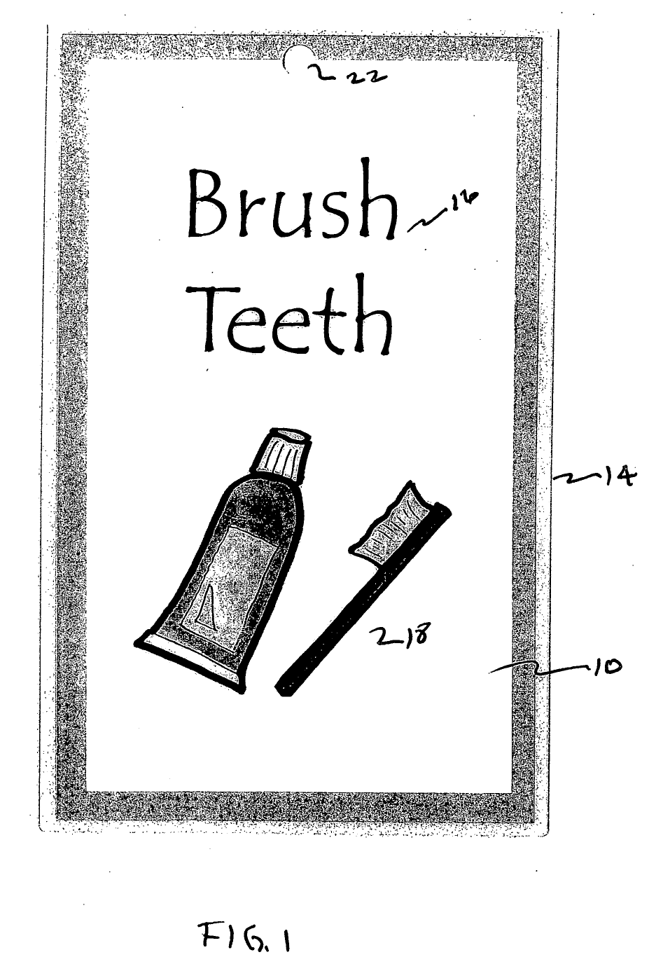

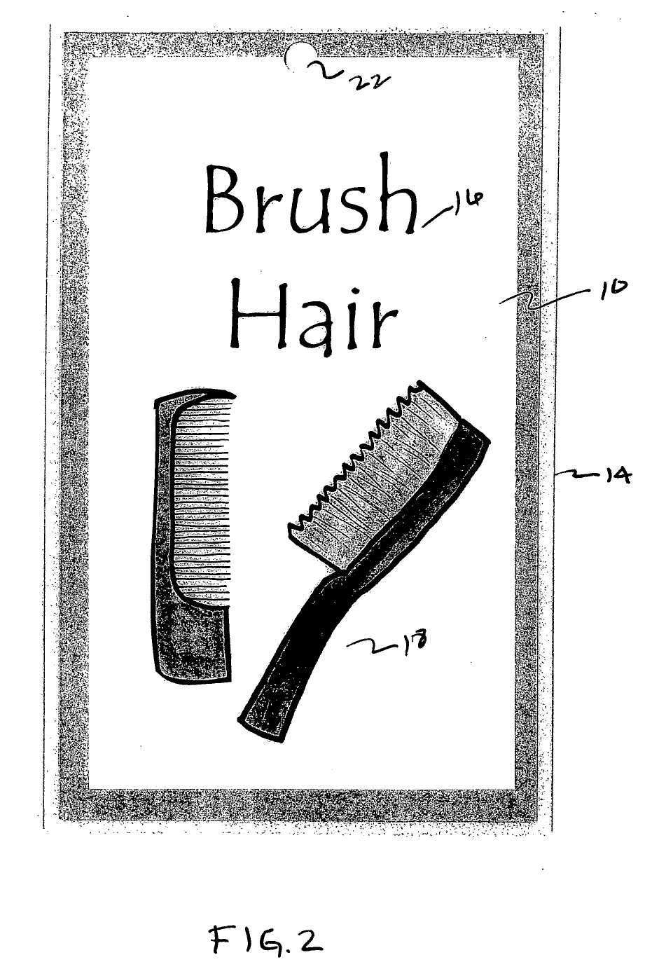

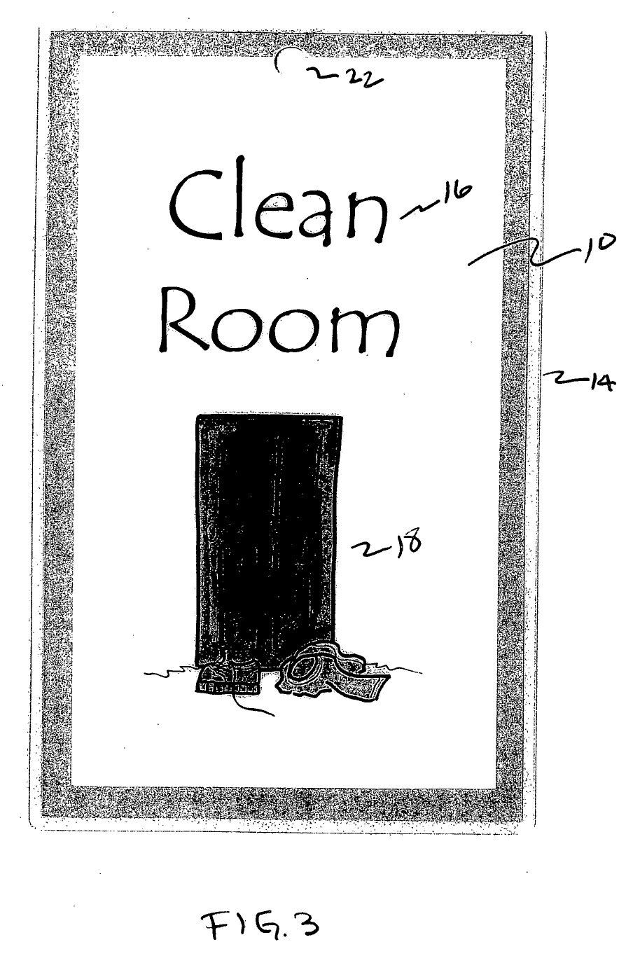

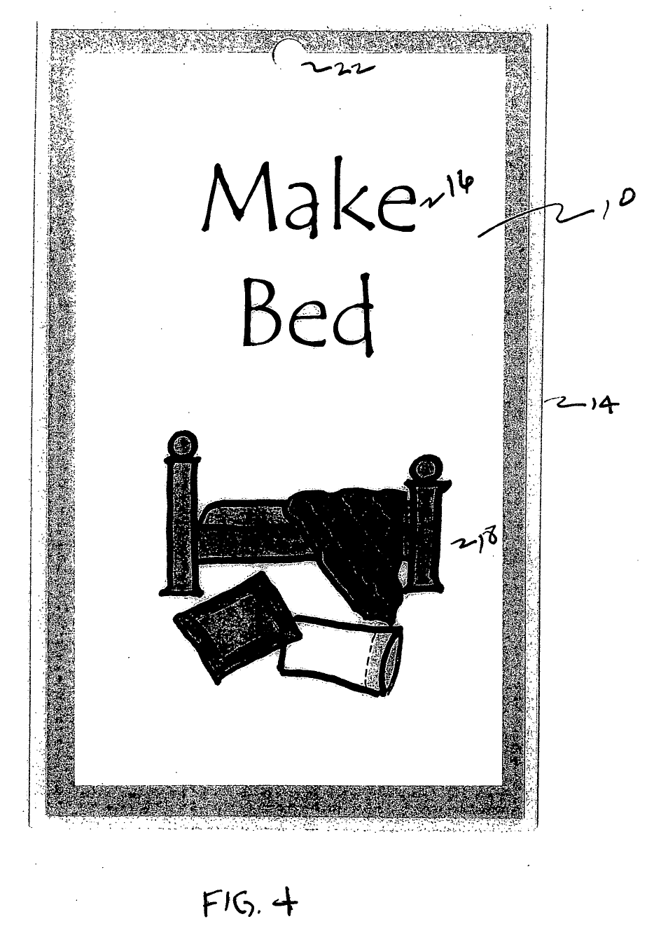

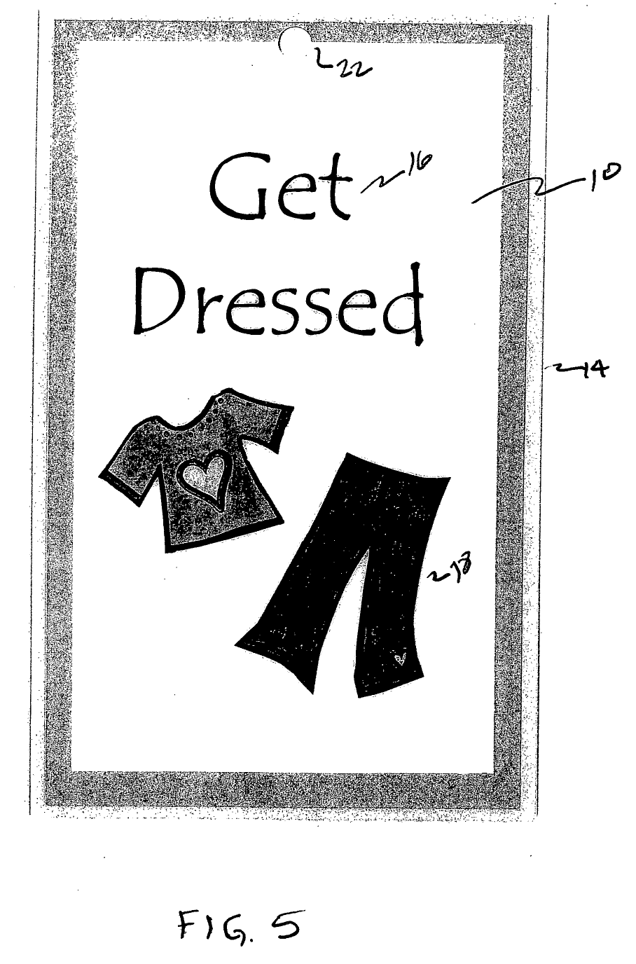

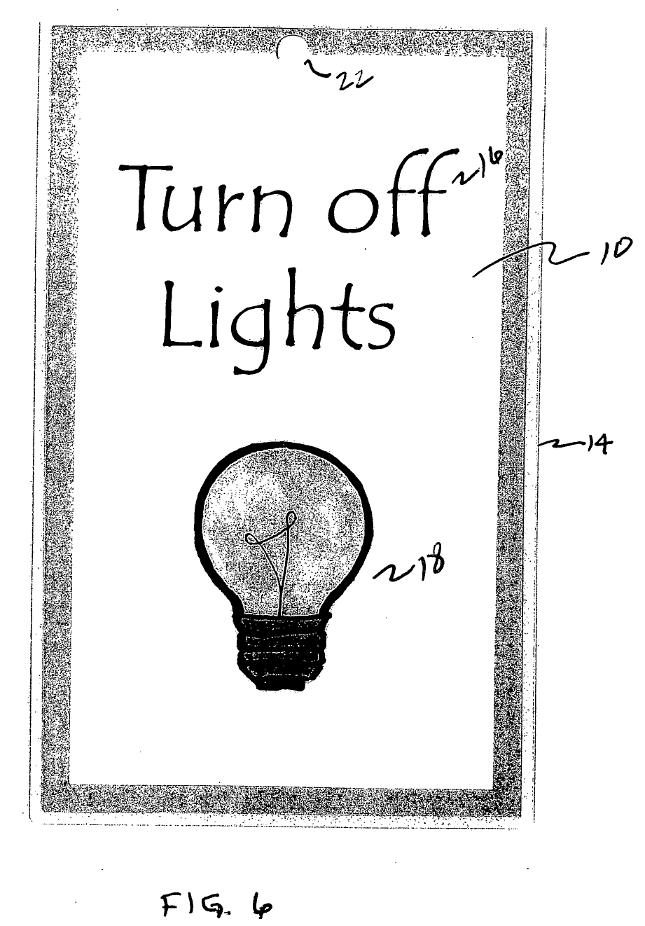

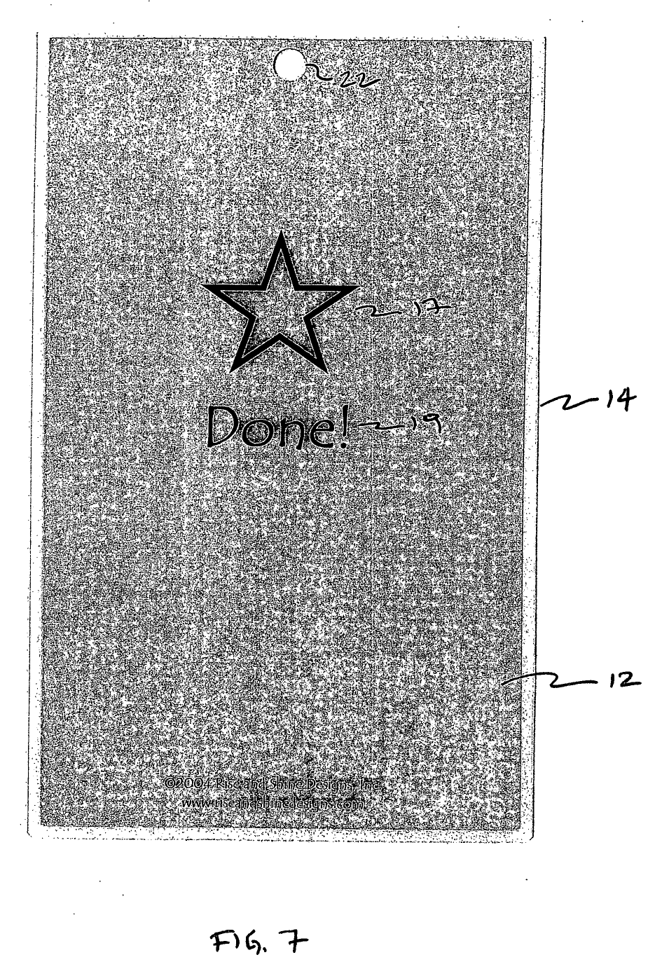

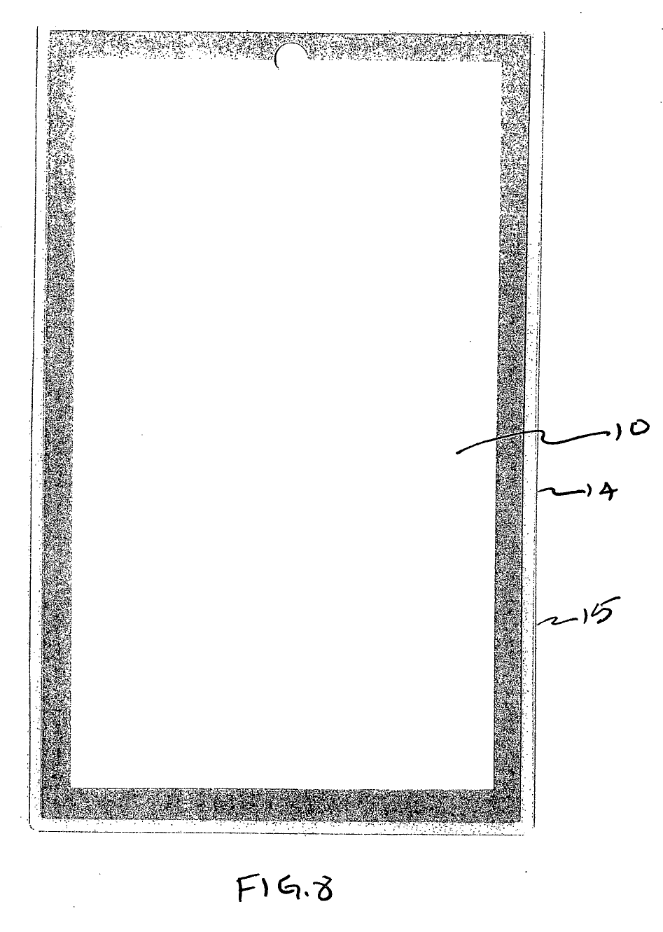

The present invention is directed to a game and more specifically to a learning game for motivating people, especially children, to complete chores or tasks (for illustrative purposes, both referred to herein as “chores”). In one exemplary embodiment, the game includes multiple cards 14. Each card has a front face 10 (FIGS. 1-6) and rear face 12 (FIG. 7). A chore 16 is identified on the front face of each card. For example, chores such as “make the bed,” “get dressed,” “clean room,” “brush teeth,” and “turn off lights” are identified on the front faces 10 of the cards 14. Exemplary cards are shown in FIGS. 1-6. In one exemplary embodiment, one card is a blank card 15 in that it has a blank front face 10, as for example shown in FIG. 8. The rear face 12 of each card may have a symbol 17, as for example a star, and/or may have wording 19, as for example “done!” indicating completion of a chore as for example shown in FIG. 7. Furthermore, in exemplary embodiments along with the chore, an illustration 18 may be provided on the front face of the card symbolizing the chore. Exemplary illustration 18 for the exemplary chores 16 are shown in FIGS. 1-6.

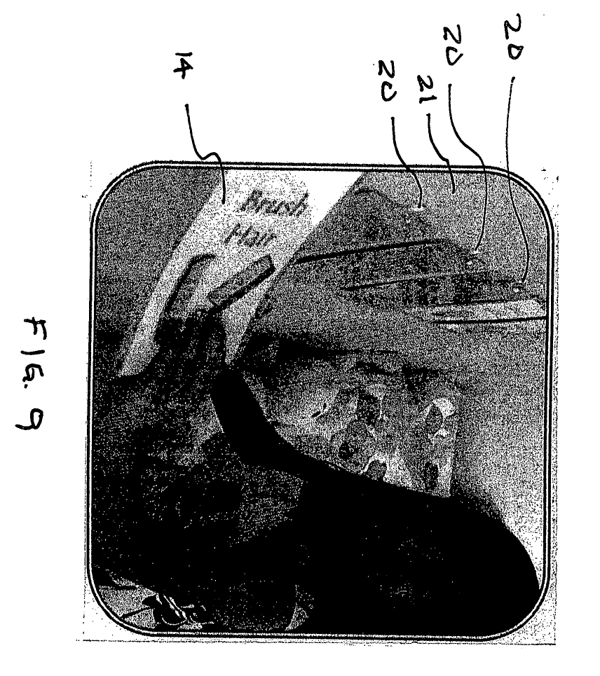

In an exemplary embodiment a set of hooks 20 that can be easily attached to a wall 21 or other surface are also provided with the game, as for example shown in FIG. 9. For example, the set of hooks may be a set of mini hooks marketed under the name Command™ Adhesive Strips by 3M. These hooks come with strips which attach to a wall or other surface. Each hook then easily attaches to each strip. Other types of hooks may be used. For example, they may be hooks that adhere directly onto the wall or that may be fastened directly to a wall.

In an exemplary embodiment where a blank card 15 is provided, a marker, as for example a pen, pencil, or felt marker, may also be provided for writing a chore to be completed onto the blank face of the card. In an exemplary embodiment, all the cards are laminated with a plastic material. In such embodiment, a marker such as a dry erase marker may be used to write over the laminate material on the front face of the blank card. This would also allow for the easy erasing of such writings. Each card also has a hole 22 or other opening proximate the top end allowing the card to be hooked onto a hook.

To play the game, in an exemplary embodiment, the hooks 20 are attached to a surface or a wall 21 and each of the cards are hooked on a corresponding hook such that the front face of each card faces away from the wall displaying the chore. In one exemplary embodiment, the wall or surface may be in the child's bedroom or other room of a house. The child will read each chore and proceed to complete it. Once a chore is completed, the child will go to the wall, unhook the card and re-hook it with the back of the card displaying completion of the chore facing away from the wall so that it is visible, as for example shown in FIG. 9. The child continues this process until all the cards are turned over denoting completion of all of the child's chores. The child may also use the marker to mark the back of the card denoting the completion of the chore noted in the front of the card. In one exemplary embodiment, the chores are completed in the order on which they are arranged on the wall or surface. In another exemplary embodiment, the chores are completed in an order different than the order on which the chore cards are arranged on the wall or surface.

In other exemplary embodiments, the set of cards may be provided for morning chores, afternoon chores, evening chores and the like. Moreover, in other exemplary embodiments, the game may be tailored for adults. For example, a set of chore cards may be provided for adults where each card of the set identifies a chore to be completed by an adult. For example a set of chores for husbands to do may be provided or a set of chores for wives to do may also be provided. In the exemplary embodiment, these chores may be humorous. In yet a further exemplary embodiment a set of chores for taking care of pets such as cats, dogs, hamsters, etc., may also be provided. Each game may comprise one set of cards or multiple sets of cards. For example, one set of cards may be for morning chores while another may be for evening chores or pet chores or other types of chores.

In yet further exemplary embodiments, the cards may be provided with an adhesive that allows them to easily attach to or detach from a wall, such as for example, the adhesive used in POST-ITS®. In yet a further exemplary embodiment, the cards are placed on a flat surface rather than being hung on a wall. With either of those aforementioned exemplary embodiments, hooks and/or holes on the chore cards may not be necessary.

Although the present invention has been described and illustrated to respect to multiple embodiments thereof, it is to be understood that it is not to be so limited, since changes and modifications may be made therein which are within the full intended scope of this invention as hereinafter claimed.

What is claimed is:

1. A method for getting a person to complete chores comprising:
providing a plurality of cards each card having a first face opposite a second face, and each card having a chore identified at the first face thereof;
positioning the cards with their first face showing the chores to be completed; and
having a person complete each chore as set forth in each card, wherein after completion of each chore the card is turned exposing the second face of the card, wherein when all the card are turned exposing their second face, the method is completed.

2. The method as recited in claim 1 wherein the second face of each card has a mark denoting completion of the chore.

3. The method as recited in claim 2 wherein said mark is the word “done”.

4. The method as recited in claim 1 further comprising marking the second face of each card when the chore set forth in each card is completed.

5. The method as recited in claim 1 wherein providing a plurality of cards comprises providing a plurality of cards each card having a first face opposite a second face, and marking the first face of each card with a marking identifying a chore.

6. The method as recited in claim 1 further comprising:
providing a set of hooks; and
mounting said hooks on a surface, wherein positioning the cards comprises mounting each card on a hook mounted on said surface, wherein each card is mounted on a different hook of said set of hooks.

7. The method as recited in claim 6 wherein after each chore is completed the appropriate card mounted on a hook of said plurality of hooks is dismounted from the hook and remounted with the second face of the card being exposed.

8. The method as recited in claim 1 wherein each chore is identified in writing in each card on said first face of each card.

9. The method as recited in claim 1 wherein each chore is identified by a figure on said first face of each card.

10. The method as recited in claim 1 wherein each chore is identified by either writing or a figure on said first face of each card.

11. The method as recited in claim 1 wherein each chore is identified by writing and a figure on said first face of each card.

12. The method as recited in claim 1 wherein providing a plurality of cards comprises providing at least one blank card and marker for marking the first face of the blank card with a marking identifying a chore.

13. A game for motivating a person to complete a chore comprising:
a plurality of cards having a first face opposite a second face and having a chore identified on the first face; and
means for suspending each of said card on a surface.

14. The game as recited in claim 13 wherein said means comprises a plurality of hooks for mounting on a surface, wherein each of said card comprises an opening for being penetrated by a hook of said plurality of hooks for mounting said card on said hook of said plurality of hooks.

15. The game as recited in claim 13 further comprising another card having a generally blank first surface.

16. The game as recited in claim 15 further comprising a marker for marking the generally blank first surface of said another card.

17. The game as recited in claim 16 wherein said card having a generally blank surface is laminated and wherein said marker is a marker for providing an erasable marking on said laminated card.

18. The game as recited in claim 13 wherein each card comprises a marking on their second face designating completion of a chore.

19. The game as recited in claim 13 wherein each card is laminated.

20. The game as recited in claim 19 further comprising a marker for erasably marking the laminated cards.

21. The game as recited in claim 13 wherein said plurality of cards forms a first set of cards and wherein the chores identified on said first set of cards are chores to be accomplished before a first event and wherein the game further comprises a second set of cards each having a first face opposite a second face and chores identified on said first face of said second set of cards to be accomplished before a second event different from the first event.
